(19) United States
(12) Patent Application Publication
(10) Pub. No.: US 2019/0087142 A1
(43) Pub. Date: Mar. 21, 2019

(54) SYSTEM AND METHOD FOR APPLYING PRINTER ACCESS POLICIES TO PAGE DESCRIPTION LANGUAGES

(71) Applicant: KONICA MINOLTA LABORATORY U.S.A., INC., San Mateo, CA (US)

(72) Inventor: Shaun PINNEY, Newark, CA (US)

(73) Assignee: KONICA MINOLTA LABORATORY U.S.A., INC., San Mateo, CA (US)

(21) Appl. No.: 15/706,147

(22) Filed: Sep. 15, 2017

(51) Int. Cl. G06F 3/12; G06K 15/02

(52) U.S. Cl. CPC G06F 3/1298; G06K 15/1805; G06F 3/1248; G06F 3/1204; G06K 15/1813

(57) ABSTRACT

A method, an image forming apparatus, and a computer program product are disclosed for applying policy to one or more page description languages or page description language transfer protocols. The method includes creating a command group which comprises two or more printer language commands and/or another command group of printer language commands, wherein, the two or more printer language commands are selected from one or more page description languages or page description language transfer protocols; storing a printer language policy in an image forming apparatus, the printer language policy configured to control access to the command group for one or more users; applying the printer language policy to the command group; and when a user requests a job comprising printer language commands, executing the job based on the printer language policy assigned to the user.

### FIELD OF THE INVENTION

The present invention relates to a system and method for applying printer access policies to page description languages (PDLs), and more particularly, to a system and method for applying policy to page description languages or page description language transfer protocols by creating command group(s) which comprise two or more commands selected from one or more PDLs or PDL transfer protocols, applying one or more printer language policies to the command group, and enforcing policy settings upon receipt or processing of a print job.

### BACKGROUND OF THE INVENTION

Image forming apparatuses (or printers) support many different printing languages such as PostScript. These Page Description Languages (i.e. PDLs) consist of commands allowing users to control printer behavior. Examples of PDLs include PostScript, Printer Command Language (PCL), Portable Document Format (PDF), and Printer Job Language (PJL), among many others. These commands provide users with access to various printer functions, such as drawing and extracting images, printing images, modifying printer default settings, uploading fonts, getting printer status, and resetting factory defaults.

Depending on the function provided by a command, the resources used by the command, or any other consideration, administrators may wish to restrict user access to commands. For example, usability and security issues may arise if all users are able to reset the printer to factory default settings, start print jobs that run forever due to endless loops in the print file's PDL, or upload a plurality of font files, which fill up the printer's available storage capacity.

As mentioned, administrators may desire to restrict access to commands for security issues and/or usage issues. For example, the effect of such restriction may be to avoid unauthorized resetting of passwords or network settings, to prevent hung jobs from blocking subsequent jobs from other users, or prevent out-of-resource conditions from blocking others from using printer features, respectively.

In addition, for example, in a case where an administrator wants to restrict all commands, which upload files to the printer, however, it may not be ideal if an administrator has to select individual file upload commands for each PDL one-by-one only to apply the same policy setting again and again to each command. Accordingly, it would be desirable to have a system and method for applying a policy to a single entity (command group) representing all file upload commands across all page description languages or page description language transfer protocols to address the above limitations.

### SUMMARY

The present disclosure has been made in consideration of the above issues, and provides an improved image forming apparatus, and to a method or process where printer administrators can applying a policy to page description languages or page description language transfer protocols for command groups, which include two or more commands or command groups.

A method is disclosed for applying policy to one or more page description languages or page description language transfer protocols, the method comprising: creating a command group which comprises two or more printer language commands and/or another command group of printer language commands, wherein, the two or more printer language commands are selected from one or more page description languages or page description language transfer protocols; storing a printer language policy in an image forming apparatus, the printer language policy configured to control access to the command group for one or more users; applying the printer language policy to the command group; and when a user requests a job comprising printer language commands, executing the job based on the printer language policy assigned to the user.

An image forming apparatus is disclosed, the image forming apparatus comprising: a memory unit, the memory unit having a firmware application which applies a policy to one or more page description languages or page description language transfer protocols, the process comprising: creating a command group which comprises two or more printer language commands and/or another command group of printer language commands, wherein, the two or more printer language commands are selected from one or more page description languages or page description language transfer protocols; storing a printer language policy in an image forming apparatus, the printer language policy configured to control access to the command group for one or more users; applying the printer language policy to the command group; and when a user requests a job comprising printer language commands, executing the job based on the printer language policy assigned to the user.

A computer program product comprising a non-transitory computer usable medium having a computer readable code embodied therein for controlling an image forming apparatus is disclosed, the computer readable program code configured to cause the image forming apparatus to execute a process for applying policy to one or more page description languages or page description language transfer protocols comprising: creating a command group which comprises two or more printer language commands and/or another command group of printer language commands, wherein, the two or more printer language commands are selected from one or more page description languages or page description language transfer protocols; storing a printer language policy in an image forming apparatus, the printer language policy configured to control access to the command group for one or more users; applying the printer language policy to the command group; and when a user requests a job comprising printer language commands, executing the job based on the printer language policy assigned to the user.

It is to be understood that both the foregoing general description and the following detailed description are exemplary and explanatory and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. In the drawings,

FIG. 1 is a data processing system, which includes a host computer and an image forming apparatus in the form of a printer connected to the host computer in accordance with an exemplary embodiment.

FIG. 2 is a diagram illustrating that each Page Description Language (PDL) can define multiple independent commands that can be used to construct PDL programs in accordance with an exemplary embodiment.

FIG. 3 is a diagram illustrating that each PDL program can consist of one or more commands selected from a single PDL.

FIG. 4 is a diagram illustrating that each PDL job can be made up of one or more PDL programs to be executed by a printer in accordance with an exemplary embodiment.

FIG. 5 is a diagram illustrating a printer can contain multiple PDL handlers, which can be used to execute programs from different PDLs in accordance with an exemplary embodiment.

FIG. 6 is a diagram illustrating a printer uses the appropriate PDL handler to execute each PDL program started by a user in accordance with an exemplary embodiment.

FIG. 7 is a flow chart illustrating PDL handling processing steps for each PDL command in accordance with an exemplary embodiment.

FIG. 8 is a diagram illustrating that in accordance with an exemplary embodiment, the system and method can allow creation of command groups and assigning printer language policies to an entire group of commands and/or a command group.

FIG. 9 is a diagram illustrating that in accordance with an exemplary embodiment, wherein the system and method is configured to allow multiple printer language policies to be attached to a single command and/or a command group.

FIG. 10 is a diagram illustrating an example of policy settings for a given user in accordance with an exemplary embodiment.

FIG. 11 is a diagram illustrating an example in which an administrator can associate policies and commands and/or command groups to one or more printers in accordance with an exemplary embodiment.

### DESCRIPTION OF THE PREFERRED EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

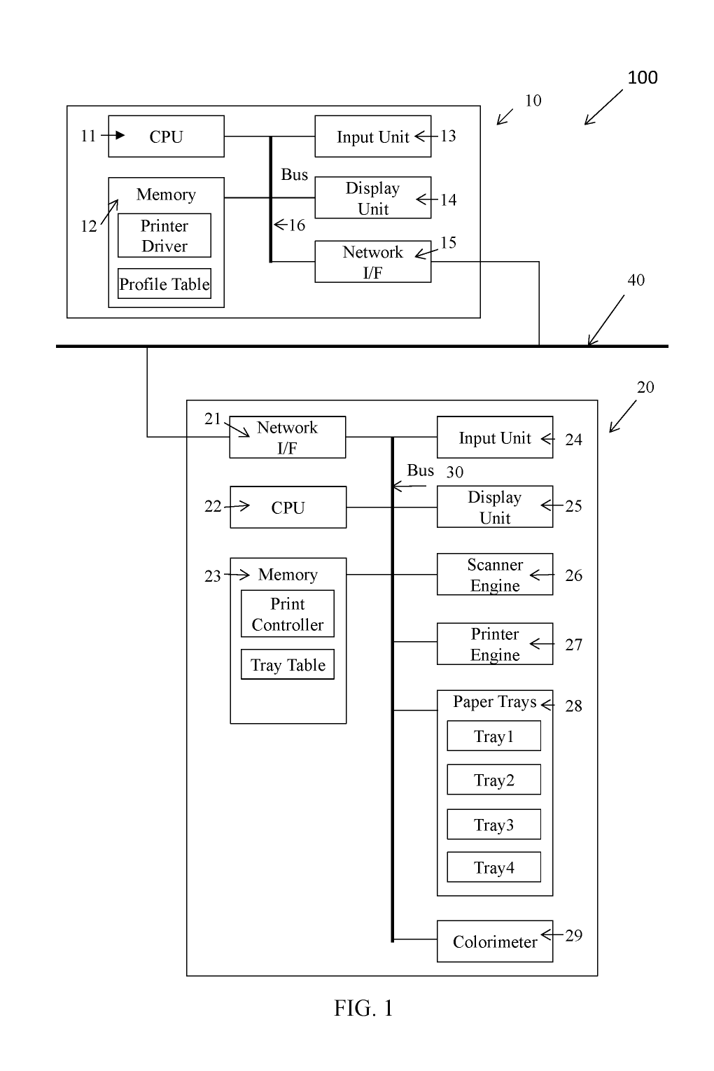

FIG. 1 is a diagram of an exemplary system 100 for applying printer access policies to Page Description Languages (PDLs) in accordance with an exemplary embodiment. As shown in FIG. 1, the system 100 can include at least one host computer or client device 10 and at least one printer or image forming apparatus 20, which are connected, for example by a communication network (or network) 40. It can be appreciated that an administrator (or printer administrator) has the ability to maintain the image forming apparatus or printer 20 within the system 100, for example, via the host or client device 10. The administrator can also be responsible for installing, supporting, and maintaining the image forming apparatus or printer 20, and planning for and responding to other problems with the system 100.

The exemplary host computer or client device 10 can include a processor or central processing unit (CPU) 11, and one or more memories 12 for storing software programs and data (such as files to be printed), and a printer driver. The printer driver of the client device 10 is preferably a software application that converts data to be printed into a form specific for the printer 20. The processor or CPU 11 carries out the instructions of a computer program, which operates and/or controls at least a portion of the functionality of the client device 10. The client device 10 can also include an input unit 13, a display unit or graphical user interface (GUI) 14, and a network interface (I/F) 15, which is connected to a communication network (or network) 40. A bus 16 can connect the various components 11, 12, 13, 14, 15 within the client device 10.

The client device 10 includes an operating system (OS), which manages the computer hardware and provides common services for efficient execution of various software programs. The software programs can include, for example, application software and printer driver software. For example, the printer driver software controls a multifunction printer or printer 20, for example connected with the client device 10 in which the printer driver software is installed via the communication network 40. In certain embodiments, the printer driver software can produce a print job and/or document based on an image and/or document data. In addition, the printer driver software can control transmission of the print job from the client device 10 to the printer or image forming apparatus 20.

The printer 20 can include a network interface (I/F) 21, which is connected to the communication network (or network) 40, a processor or central processing unit (CPU) 22, and one or more memories (or memory units) 23 for storing software programs and data (such as files to be printed). For example, the software programs can include a printer controller (or firmware) and a tray table. The processor or CPU carries out the instructions of a computer program, which operates and/or controls at least a portion of the functionality of the printer 20. The printer 20 can also include an input unit 24, a display unit or graphical user interface (GUI) 25, a scanner engine (or scanner) 26, a printer engine 27, at least one auto tray or paper tray 28, and more preferably a plurality of auto trays or paper trays, 28, for example, Tray 1, Tray 2, Tray 3, Tray 4 . . . Tray N, and a colorimeter 29. The auto tray or paper tray 28 can include a bin or tray, which holds a stack of a print media, for example, a paper or a paper-like product. In accordance with an exemplary embodiment, for example, the colorimeter 29 can be one or more color sensors or colorimeters, such as an RGB scanner, a spectral scanner with a photo detector or other such sensing device known in the art, which can be embedded in the printed paper path, and an optional finishing apparatus or device (not shown). A bus 30 can connect the various components 21, 22, 23, 24, 25, 26, 27, 28, 29 within the printer 20. The printer 20 also includes an operating system (OS), which manages the computer hardware and provides common services for efficient execution of various software programs.

In accordance with an exemplary embodiment, it can be within the scope of the disclosure for the printer 20 to be a copier. The printer engine or print engine 27 has access to a print media of various sizes and workflow for a print job, which can be, for example, stored in the input tray. A “print job” or “document” can be a set of related sheets, usually one or more collated copy sets copied from a set of original print job sheets or electronic document page images, from a particular user, or otherwise related.

For example, in accordance with an exemplary embodiment, an image processing section within the printer 20 can carry out various image processing under the control of a print controller (or firmware) or CPU 21, and sends the processed print image data to the print engine 27. The image processing section can also include a scanner section (scanner 26) for optically reading a document, such as an image recognition system. The scanner section receives the image from the scanner 26 and converts the image into a digital image. The print engine 27 forms an image on a print media (or recording sheet) based on the image data sent from the image processing section. The central processing unit (CPU) (or processor) 22 and the memory (or memory unit) 23 can include a program for RIP processing (Raster Image Processing), which is a process for converting print data included in a print job into Raster Image data to be used in the printer or print engine 27. The CPU 22 can include a printer controller configured to process the data and job information received from the one or more client devices 10, for example, received via the network connection unit and/or input/output section (I/O section) 24.

The CPU 22 can also include an operating system (OS), which acts as an intermediary between the software programs and hardware components within the multi-function peripheral. The operating system (OS) manages the computer hardware and provides common services for efficient execution of various software applications. In accordance with an exemplary embodiment, the printer controller can process the data and job information received from the one or more client devices 10 to generate a print image.

The network I/F 21 performs data transfer with the client device 10. The printer controller can be programmed to process data and control various other components of the multi-function peripheral to carry out the various methods described herein. In accordance with an exemplary embodiment, the operation of printer section commences when it receives a page description from the one or more client devices 10 via the network I/F 21 in the form of a print job data stream and/or fax data stream. The page description may be any kind of page description languages (PDLs), such as PostScript® (PS), Printer Control Language (PCL), Portable Document Format (PDF), and/or XML Paper Specification (XPS). Examples of printers 20 consistent with exemplary embodiments of the disclosure include, but are not limited to, a multi-function peripheral (MFP), a laser beam printer (LBP), an LED printer, a multi-function laser beam printer including copy function.

In accordance with an exemplary embodiment, the communication network or network 40 can be a public telecommunication line and/or a network (for example, LAN or WAN). Examples of the communication network 40 can include any telecommunication line and/or network consistent with embodiments of the disclosure including, but are not limited to, telecommunication or telephone lines, the Internet, an intranet, a local area network (LAN) as shown, a wide area network (WAN) and/or a wireless connection using radio frequency (RF) and/or infrared (IR) transmission.

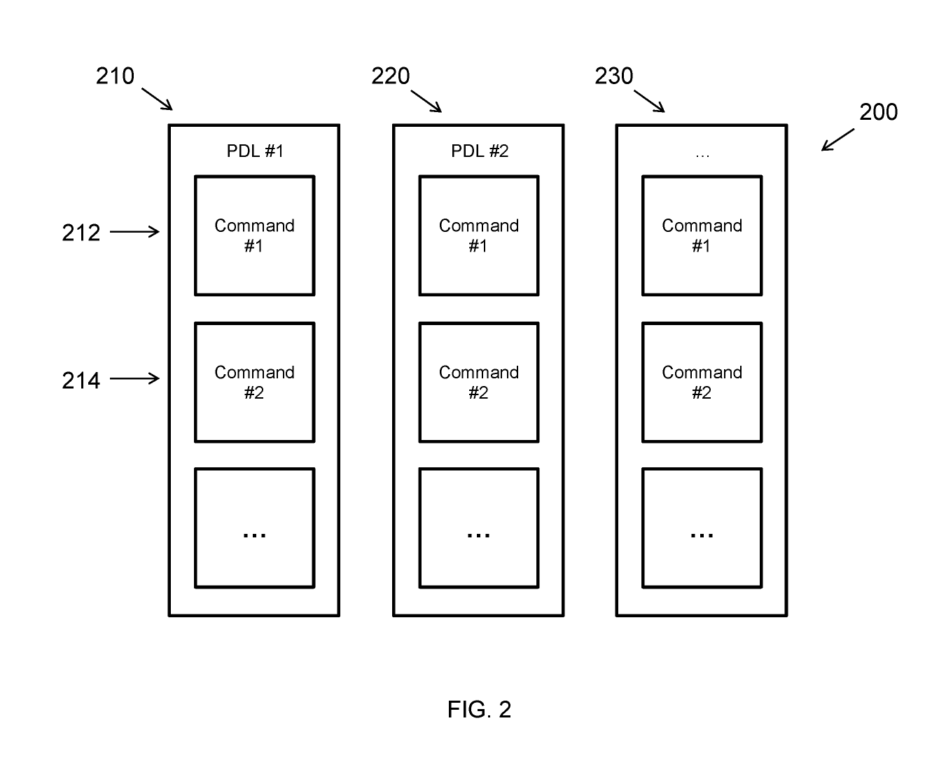

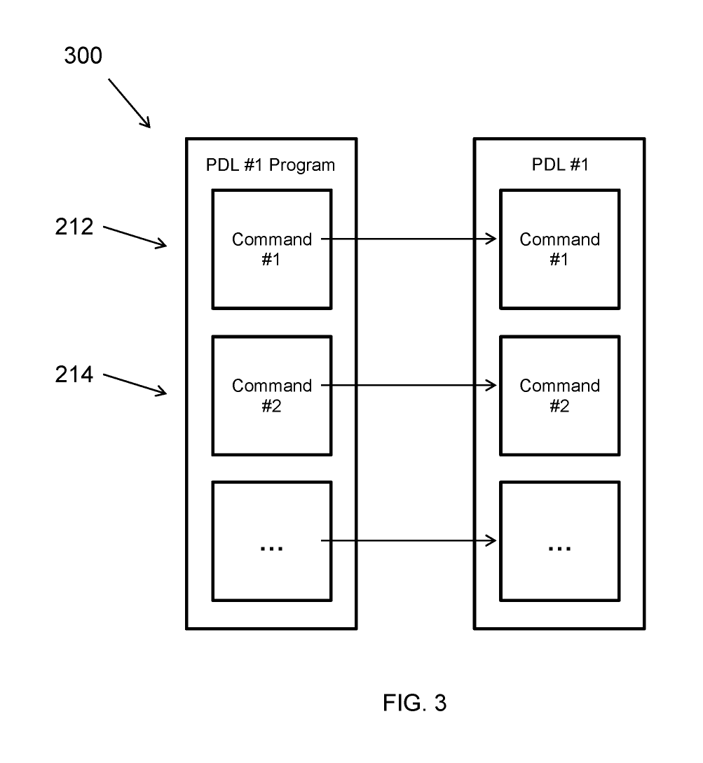

FIG. 2 is a diagram 200 illustrating the each Page Description Language (PDL) 210, 220, 230 can define multiple independent commands or printer language commands 212, 214 that can be used to construct PDL programs in accordance with an exemplary embodiment. As shown in FIG. 2, each of the PDLs 210, 220, 230 can include one or more printer language commands 212, 214 that can be used to construct PDL programs 300 (FIG. 3) as disclosed herein. In accordance with an exemplary embodiment, it would be desirable for an administrator to have a system and method to group printer language commands (or PDL commands) together and apply policies (for example, a printer language policy) to the entire command group as disclosed herein rather than individual printer language commands.

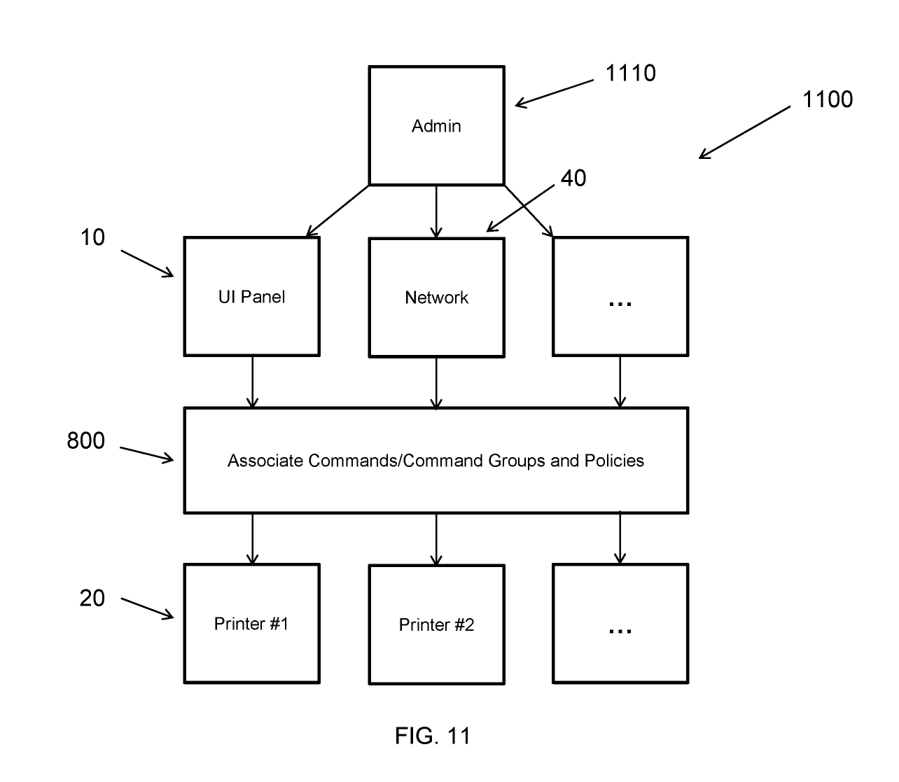

In accordance with an exemplary embodiment, each of the one or more commands (i.e., printer language features and the corresponding printer language settings) provide users with the ability to affect how the image forming apparatus operates and/or prints a print job. For example, the printer languages features can include PostScript, PCL (Printer Command Language), and/or PJL (Printer Job Language) languages. In accordance with an exemplary embodiment, the administrator 1110 (FIG. 11) can control user access to the PCL (Printer Command Language) feature of an image forming apparatus 20, which allows, for example, users to download new fonts to the image forming apparatus (or printer) 20, which fonts can be used by subsequent print jobs.

In accordance with an exemplary embodiment, the printer language commands or commands 212, 214 can include settings related to: fonts, page format and spacing, number of print copies, tray selection and/or assignment, hard drive and/or memory, printing a single page of a document, the entire document, or a range of pages in the document, printing multiple copies of a document, printing the pages in a document in reverse order, printing multiple pages of a document on a single page of paper, landscape and portrait printing, printing on different page sizes, printing labels, duplex printing where both sides of a page are printed, and/or printing with watermarks. In addition, default values (or settings) can be set to include settings related to: page length for front and rear tractor, skip over perforations, auto tear off, auto line feed, print direction, software 0 slash, I/F (interface) mode, Auto I/F (interface) wait time, parallel I/F bidirectional mode, packet mode, character tables including international character set for italic table, manual feed wait time, buzzer, and Auto CR (carriage return).

In addition, the PDLs 210, 220, 230 and specific commands 212, 214 can also include operations within the scanner section, the copier section, and the facsimile section of the image forming apparatus or printer 20. For example, the PDLs 210, 220, 230 can control access to the memory and hard drive of the image forming apparatus or printer 20 for each of the plurality of users, control storage, printing and/or deletion of print, scan, copy and facsimile jobs within the memory and hard drive of the image forming apparatus or printer 20, and control access to certain documents or images stored within the image forming apparatus or printer 20.

FIG. 3 is a diagram illustrating that each PDL program 300 can consist of one or more commands 212, 214, 216 selected from a single PDL 210. In accordance with an exemplary embodiment, a PDL program 300, for example, can be used to print a print job having one or more image data rendering commands 212, 214, 216. For example, as shown in FIG. 3, the PDL program 300 can include command #1 212 and command #2 214 from PDL #1 210.

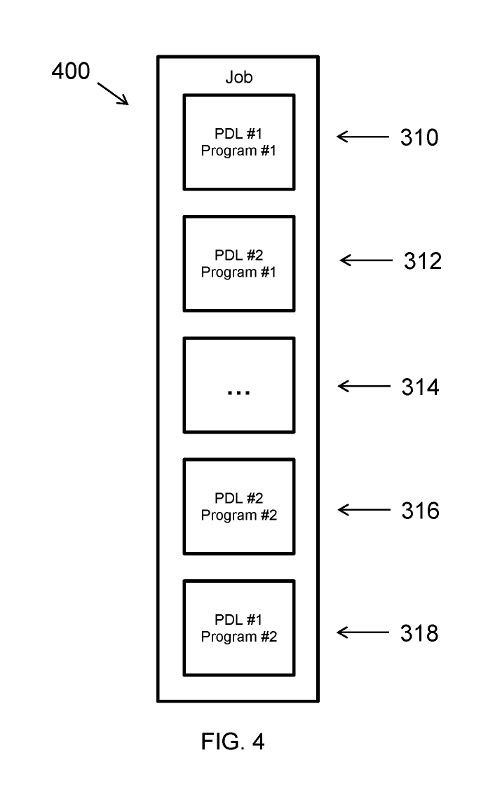

FIG. 4 is a diagram illustrating that each PDL job 400 can be made up of one or more PDL programs 310, 312, 314, 316, 318 to be executed by a printer 20 in accordance with an exemplary embodiment. As shown in FIG. 4, for example, the PDL job 400 can include commands from, for example, PDL #1, Program #1 310, PDL #2, Program #1 312, . . . 314, PDL #2, Program #2 316, and PDL #1, Program #2 318,

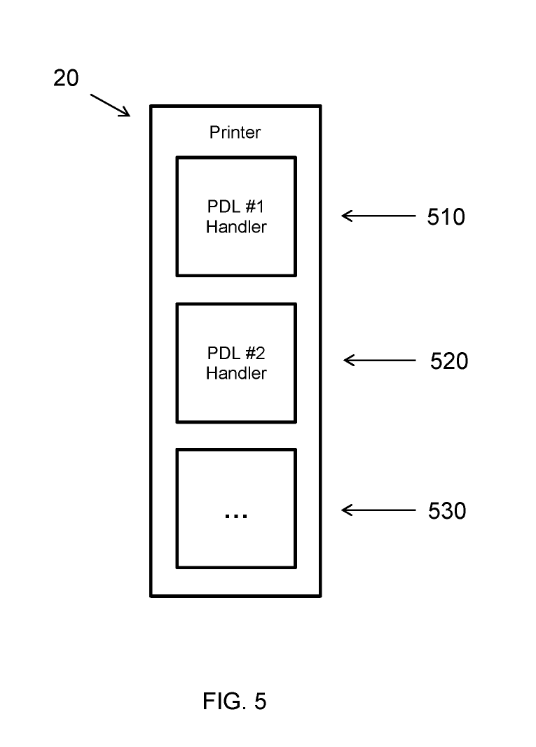

FIG. 5 is a diagram illustrating a printer 20 can contain at least one PDL handler 510, 520, 530, and more preferably multiple PDL handlers 510, 520, 530, which can be used to execute programs from different PDLs. In accordance with an exemplary embodiment, the PDL handlers 510, 520, 530 can be a routine, a function, or a method hosted on the image forming apparatus or printer 20 and configured to execute the PDL commands 310, 312, 314, 316, 318 within a print job or job 400. In accordance with an exemplary embodiment, for example, the printer 20 can have one or more PDL handlers 510, 520, 530 configured to execute the PDL commands 212, 214.

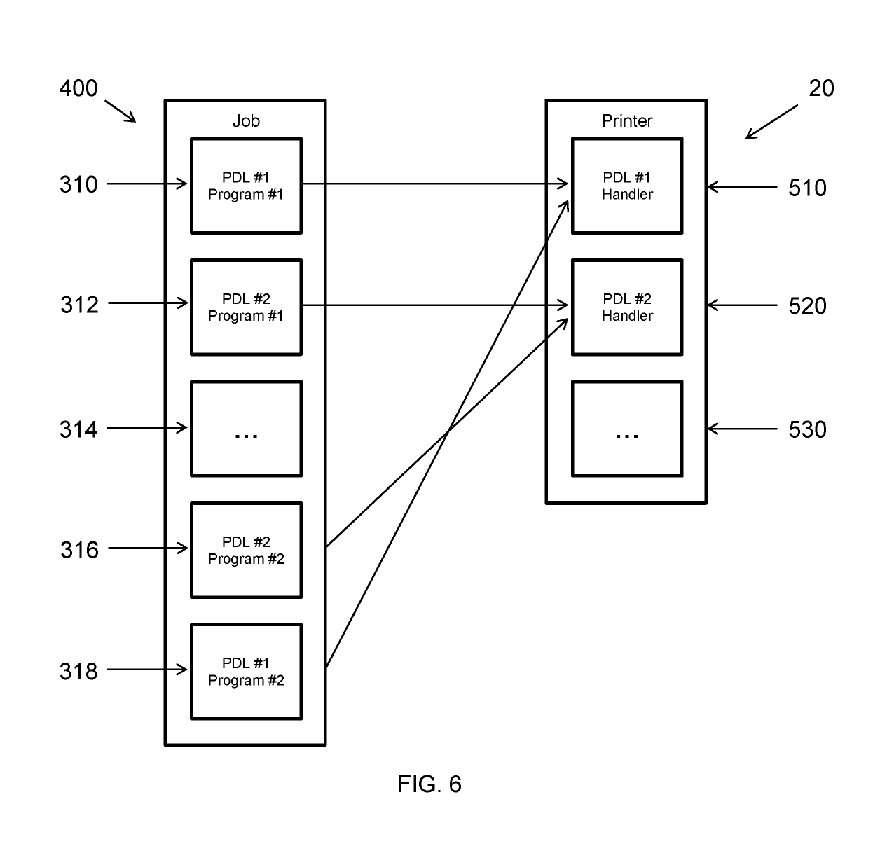

FIG. 6 is a diagram illustrating a printer 500 can be configured to use the appropriate PDL handler 510, 520, 530 to executed each PDL program 310, 312, 314, 316, 318 started by a user in accordance with an exemplary embodiment. As shown in FIG. 6, the printer 20 can include two or more PDL handlers 510, 520, 530, which are configured to execute one or more PDL programs 310, 312, 314, 316, 318.

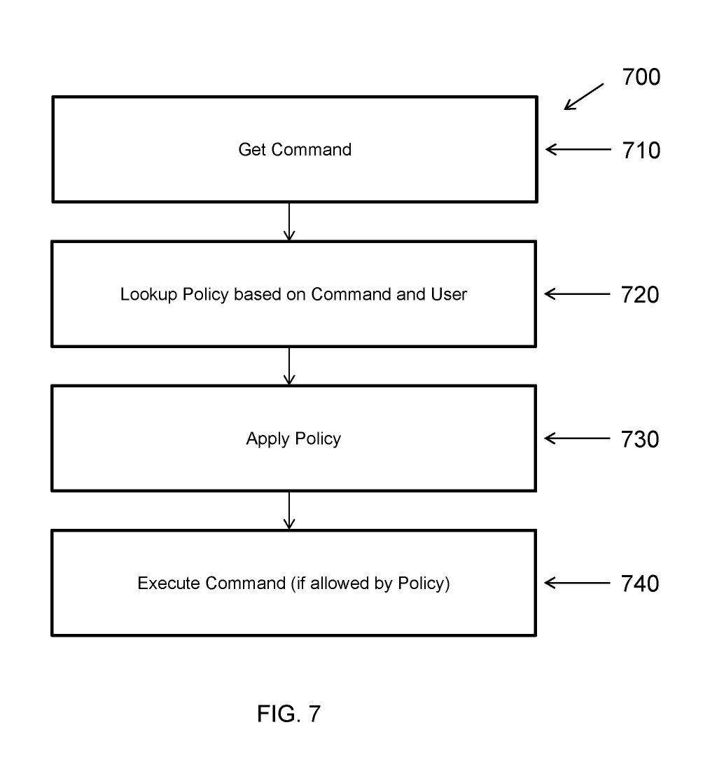

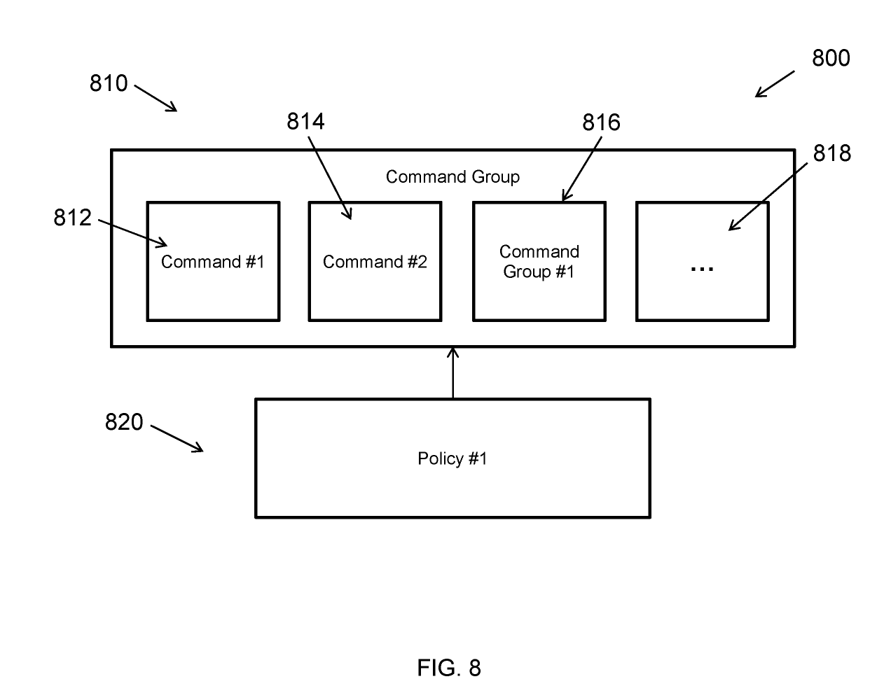

FIG. 7 is a flow chart 700 illustrating PDL handling processing steps for each PDL command in accordance with an exemplary embodiment. As shown in FIG. 7, in step 710, the PDL handler 510, 520, 530 gets (or receives) the command 212, 214. In step 720, the PDL handler 510, 520, 530 obtains a policy, for example, from a lookup policy database, based on the command and user. In step 730, the policy 820 received from the lookup policy database is applied to the PDL command 212, 214. In step 740, the command 212, 214 is executed, if permitted or allowed by policy 820 (FIG. 8). In accordance with an exemplary embodiment, for example, the lookup policy database can be hosted on the printer 20, for example, in the memory 23 of the printer 20. However, the lookup policy database can also be hosted, for example, on a remote server (not shown).

In accordance with an exemplary embodiment, since it may be difficult for an administrator 1110 (FIG. 11) to know which of the commands 212, 214 to group together to achieve a desired result without becoming familiar with all of the commands 212, 214 in each and every PDLs supported by a printer 20, a system and method are disclosed, for establishing command groups, which comprise two or more commands or a command group. For example, attempting to apply a policy to all commands, which upload fonts, for example, requires knowledge of which commands in PostScript, PCL, and all other PDLs, which support this feature. In addition, for example, applying a policy to commands, which write to NVRAM to avoid NVRAM failure due to excessive writes, may be difficult for an administrator to fully understand. For example, creating such a group for writing to NVRAM may be difficult to achieve since the grouping changes from printer-to-printer and is not typically documented, and if the administrator, for example, misses a relevant command for any reason, then there can be a gap, which leaves open potential usability or security issues.

In accordance with an exemplary embodiment, it would be desirable to has a system and method, which supports grouping of commands that meet a given criteria for one or more printers 20, which can add greater control, make it easier for administrators to set policies that apply to multiple commands or commands that cross PDL boundaries, and also reduce opportunities for unexpectedly opening a security or usability hole by missing a particular PDL or PDL command.

In addition, it would be desirable if an administrator had a system and method to group PDL commands together and apply a policy once to an entire group of commands 212, 214, which can, for example, reduce the time required for applying policy settings to an image forming apparatus or printer 20. For example, if the administrator needs to change a policy for multiple commands that are already grouped, the policy settings can be modified once for the group rather than one-by-one. In addition, if new policies are added, for example, by a firmware upgrade, then new policies can be easily applied to existing groups. In accordance with an exemplary embodiment, policies can be applied to multiple commands and even commands across multiple PDLs in a very flexible manner, improving the administrator's capabilities.

In accordance with an exemplary embodiment, for the system and method can support the grouping of commands that meet a given criteria, which can also add greater control and make it easier to set policies that apply to multiple commands or commands that cross PDL boundaries. In addition, by grouping commands that meet a given criteria, the system and method can reduce concerns about unexpectedly opening a security or usability hole by missing a particular PDL or PDL command. In addition, by providing command grouping support for PDLs and allowing policies to be applied to groups in addition to individual commands, administrator management for printer usability and security can provide improved capabilities to meet usability and security requirements

In accordance with an exemplary embodiment, to provide this grouping improvement, default command groups and default settings can be based on printer manufactures to meet common administrative goals out-of-the box (for example, restrict factory reset commands to administrators only). In addition, users can also be given control to customize existing groups or to create their own groups. In accordance with an exemplary embodiment, a system to create user groups can include solutions, for example, such as basing the user groups on existing group and customizing settings, or more complex systems such as allowing users to send queries to a command database which contains PDL commands and characteristics (for example, command1 writes to NVRAM), where the query selects commands that match the user's criteria (for example, all commands that write to NVRAM) and the system allows for creating a group from commands returned by the query. In accordance with an exemplary embodiment, a framework for PDL command grouping exists, which is capable of supporting not only existing PDLs and policies, but also capable of supporting new PDLs, new resource dependencies, custom PDL extensions, and new policy control mechanisms as they arise. In addition, the system and method can provide flexibility for control over usability and security even as PDL and policy technologies evolve over time for administrators.

In accordance with an exemplary embodiment, the system and method is disclosed, which can allow different policies to be set or applied for different users and user groups, which can help with administrators with control over printer security and usability. For example, one command group may be given a policy, which applies to one group of users and not another group. In addition, an administrator can create a group for all PostScript commands, apply a policy to the group, which limits total command execution time per job/page, and have the policy apply to all users except for administrators. In accordance with another exemplary embodiment, an administrator can create a group for all commands that write to or delete files, apply a policy to the group such that only the owner of a file can write or delete a file, and have the policy apply to all users except for administrators.

In accordance with an exemplary embodiment, for example, when a user requests a print job, a first policy (or first prior policy) applicable to a printer language command of the print job is first looked up in the policy database. However, when there is no applicable policy to the printer language command of the print job in the first policy, a second policy (or second prior policy) for the printer language command of the print job can be looked up in the policy database. Policies may also indicate the next policy to check to allow administrators to construct flexible, tree-like, policy schemes.

In accordance with an exemplary embodiment, the system and method as disclosed, can be applied to PDLs for other job types, for example, scan/fax/etc. In addition, the system and method can be extended to apply to commands used by network protocols for other job types, for example scan: TWAIN, fax: IFAX, etc. In addition, the term “commands” applies to all PDL language elements and capabilities (for example, parameters, return values, syntax, operator overloading/redefinition, etc.)

In accordance with an exemplary embodiment, administrators can also obtain statistics and information about command groups (for example, which users made use of given command or command group, number of accesses per job, per page, per month, total, etc.). In addition, logging and notification when specific commands or command groups are used (for example, which user, date/time, e-mail administrator, store in internal log, etc.) can be provided to an administrator. In accordance with an exemplary embodiment, the system and method as disclosed herein can be used for query database content (for example, can allow queries for printer-specific resources such as Imaging Unit, Toner Cartridges, Duplexer, Stapler, Input Tray, Output Tray, Manual Feed Tray, Automatic Document Feeder, Flatbed, Fax, etc.) In accordance with an exemplary embodiment, an administrator can create command groups and associate policies for one or more printers via, for example, a User Interface (UI) such as UI Panel, Web Page, etc., for example, on a host computer or client device 10.

FIG. 8 is a diagram 800 illustrating that in accordance with an exemplary embodiment, the system and method can allow creation of command groups and assigning policies to an entire group. For example, as shown in FIG. 8, a command group 810 can be created, which can include commands and command groups 812, 814, 816, 818. Each of the commands 812, 814 and command groups 816, 818, can consist of a PDL command 812, 814, or a plurality of PDL commands 816.

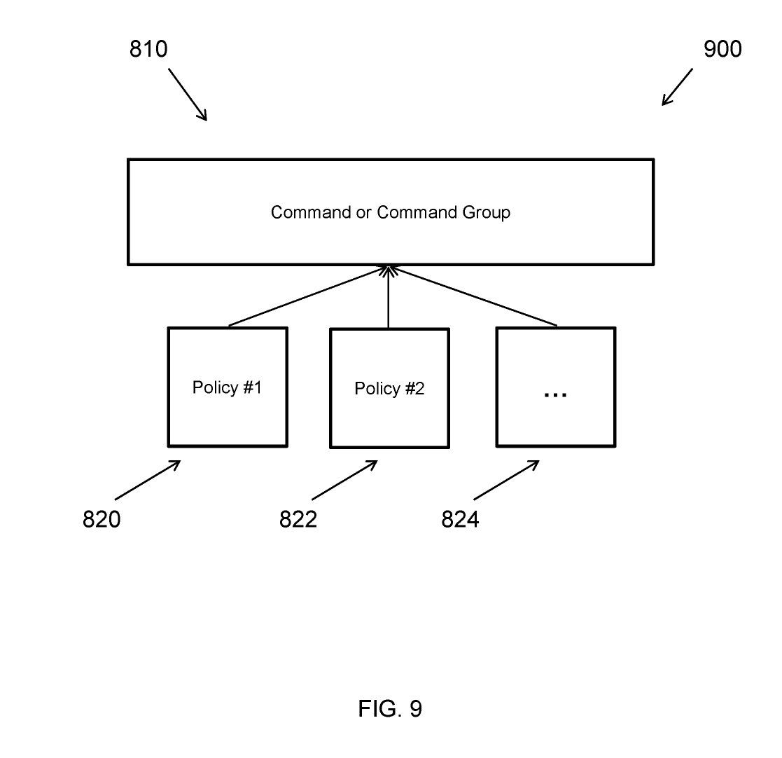

FIG. 9 is a diagram 900 illustrating that in accordance with an exemplary embodiment, the system and method can allow multiple policies to be attached to a single command or command group 810. As shown in FIG. 9, the command or command group can have one or more policies attached 820, 822, 824. In accordance with an exemplary embodiment, the system and method can also provide an administrator the ability to attach multiple policies 820, 822, 824 to the same command or command group (for example, policy 1 may apply to some users, policy 2 may apply to other users, etc.). Furthermore, the policies 820, 822, 824 can be checked in a designated order, alternatively, out of order (for example, if policy 1 does not match, check next policy/jump to policy n, etc.). The benefit is to allow administrators the ability to apply complex policies with and/or/if/etc., relations to command groups by creating smaller, simpler to manage policies, chaining them together, and attaching to a command group. For example, policy 1 may prevent command execution for guest users and policy 2 may allow command execution. So, by first attaching policy 1 to a command group containing all font upload commands and next attaching policy 2 to the command group with ‘else’ relation, then a complex policy can be created such that all users can upload fonts except, for example, guest users. In accordance with an exemplary embodiment, for example, guest users, can include non-employees of a company or business, a user without a password or credentials to access a company networks, and, for example, a printer or image forming apparatus within the building or office.

In accordance with an exemplary embodiment, the system and method can provide the administrator with the ability to attach policy profiles to commands and command groups based on user attributions, for example, applying an unrestricted access policy for administrators, apply guest access policy for unauthenticated users, apply normal access policy for authenticated users, etc. For example, in accordance with an exemplary embodiment, a policy profile for administrators may contain a single policy to allow command execution, whereas a policy profile for guest users may contain multiple policies to allow execution for commands that do not access the hard disk drive (HDD), and disable all others. In accordance with an exemplary embodiment, for example, attaching these policy profiles to a command group containing all PDL commands can help prevent HDD security issues for guest users.

In accordance with an exemplary embodiment, authentication is not necessary to restrict user access to printer features, for example, a user group can be setup for unauthenticated/guest users and granted minimal access. For example, restrict unauthenticated users from using commands that change default settings, passwords, reset to factory default settings, specify non-monochrome colors in PDL commands, etc. In accordance with an exemplary embodiment, administrators are allowed a way to control access for users in cases where some printer capabilities are made available without requiring user login first, which remains a very common scenario but increases risk for security and usability concerns in a multi-user environment.

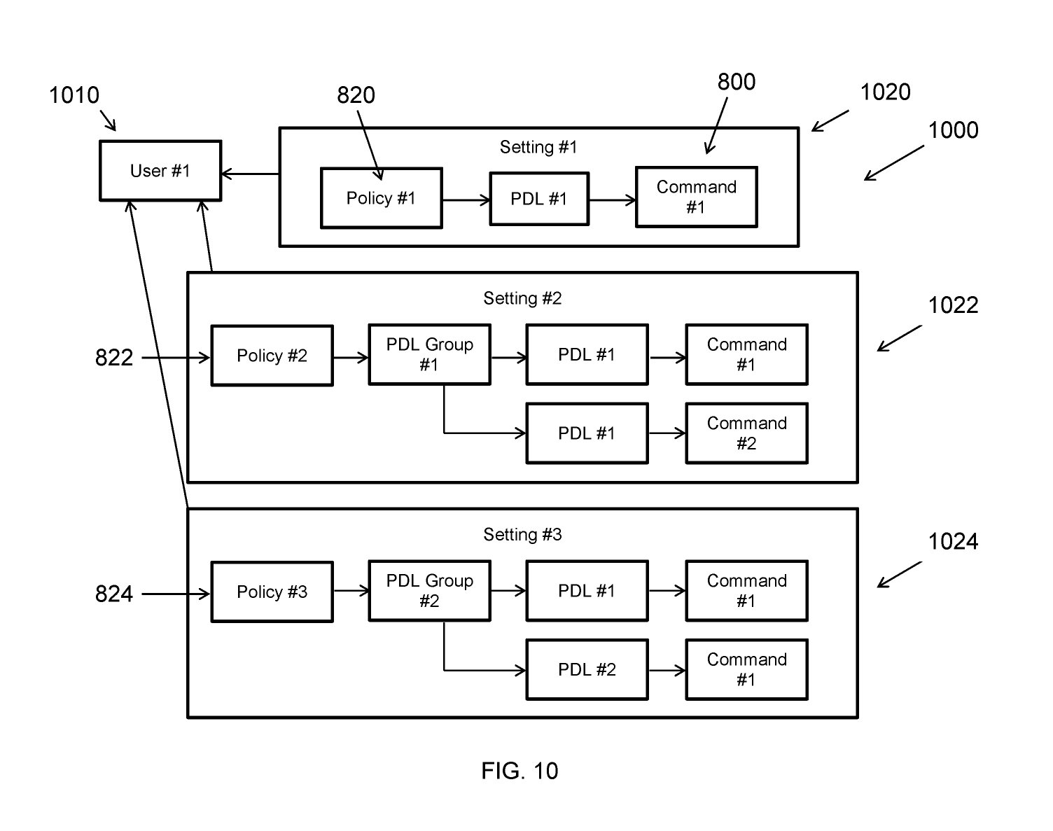

FIG. 10 is a diagram 1000 illustrating an example of policy settings for a given user 1010 in accordance with an exemplary embodiment. As shown in FIG. 10, each of the one or more users 1010 can have one or more policy settings 1020, 1022, 1024. Each of the one or more policy settings 1020, 1022, 1024, can include a policy 820, 822, 824, and one or more commands or command groups 810 as disclosed herein.

FIG. 11 is a diagram 1100 illustrating an example in which an administrator 1110 can associate policies and commands/command groups in accordance with an exemplary embodiment. As shown in FIG. 11, the administrator 1110 can implement the commands, command groups, and policies 800 via a client or host device 10 having graphical user interface or user interface panel (US panel) or display unit 14. In accordance with an exemplary embodiment, the administrator 1110 can implement and configure the commands, command groups and polices 800 as disclosed herein for one or more image forming apparatuses or printers 20. In accordance with an exemplary embodiment, for example, the administrator 1110 can implement and manage the commands, command groups, and policies 800 via the communication network 40. However, it can be appreciated that the commands, command groups and policies 800 can be entered into the image forming apparatus or printer 20 by any suitable method, for example, during updating of firmware for the image forming apparatus or printer 20.

In accordance with another exemplary embodiment, a computer program product comprising a non-transitory computer usable medium having a computer readable code embodied therein for controlling an image forming apparatus is disclosed, the computer readable program code configured to cause the image forming apparatus to execute a process for applying policy to one or more page description languages or page description language transfer protocols comprising: creating a command group which comprises two or more printer language commands and/or another command group of printer language commands, wherein, the two or more printer language commands are selected from one or more page description languages or page description language transfer protocols; storing a printer language policy in an image forming apparatus, the printer language policy configured to control access to the command group for one or more users; applying the printer language policy to the command group; and when a user requests a job comprising printer language commands, executing the job based on the printer language policy assigned to the user.

It can be appreciated that the process and method can be introduced into the apparatus by updating the firmware in the non-volatile memory of the image forming apparatus. In this regard, the method may be brought to the apparatus in a form of a package of install software and the firmware, which may be divided and/or compressed so that the install software effectively installs the firmware. The package may be steadily stored in a computer readable diskette, such as a compact disk, or may be transmitted through a wire/wireless communication line.

The method described above can be used to print on paper or other suitable printing medium such as thin plastic sheets, etc. The computer readable medium, of course, may be a magnetic recording medium, a magneto-optic recording medium, or any other recording medium which will be developed in future, all of which can be considered applicable to the present disclosure in all the same way. Duplicates of such medium including primary and secondary duplicate products and others are considered equivalent to the above medium without doubt. Furthermore, even if an embodiment of the present disclosure is a combination of software and hardware, it does not deviate from the concept of the disclosure at all. The present disclosure may be implemented such that its software part has been written onto a recording medium in advance and will be read as required in operation.

While a print job is described in detail above, the method and process can also be applied to a copy job, where a user supplies an original hard copy. Thus, as used in this disclosure and the appended claims, the term “image forming apparatus”, “printer” or “printing device” should be broadly understood to refer to any machine that has a print function, including printers, copiers, and all-in-one machines, which have printing, scanning, and copying functions. The term “printing” similarly includes both printing and copying, for example, printing can refer to producing images on a recording medium either from a data received from an external device such as a host computer or from data generated by scanning an original hard copy.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

1. A method for applying policy to one or more page description languages or page description language transfer protocols, the method comprising:
creating command groups of printer language commands, each of the command groups comprises two or more printer language commands selected from one or more page description languages or page description language transfer protocols;
storing at least two printer language policies for each of the command groups in an image forming apparatus, each of the at least two printer language policies configured to concurrently control access to the two or more printer language commands of a command group for one or more users during an execution of a job, and wherein each of the at least two printer language policies is configured to be set independently of each other;
assigning at least one user to each of the at two printer language policies;
applying a printer language policy of the at least two printer language policies for the command group when a user requests the execution of the job with the one or more page description languages or page description language transfer protocols; and
executing the job based on the printer language policy assigned to the user, wherein the execution of the job comprises printing a print job on a sheet of print media according to the command group and/or displaying policy information on a display panel of the image forming apparatus according to the command group.

2. The method of claim 1, comprising:
creating the command groups based on printer language commands having a same function.

3. The method of claim 1, comprising:
creating the command groups based on printer-specific resources for the image forming apparatus.

4. The method of claim 1, comprising:
creating the command groups based on user attributions.

5. The method of claim 1, wherein the command groups comprise different page description languages, and wherein the different page description languages are selected from the following:
PostScript, Printer Command Language (PCL), Printer Job Language (PJL), Portable Document Format (PDF), XML Paper Specification (XPS), TWAIN, and IFAX.

6. The method of claim 1,
when the user requests the job, looking up a first policy applicable to a printer language command of the job, and
when there is no first policy applicable to the printer language command of the job, looking up a second policy applicable to the printer language command of the job.

7. The method of claim 1, further comprising:
reporting statistics and/or information about the command groups to an administrator via a display unit on a host device or the image forming apparatus.

8. The method of claim 1, further comprising:
when the user requests to execute a printer language command for the image forming apparatus, determining whether the user is authorized to execute the printer language command based on the printer language policy settings for the user;
when it is determined that the user is authorized to execute the printer language command of the image forming apparatus, executing the printer language command of the image forming apparatus; and
when it is determined that the user is not authorized to execute the printer language command of the image forming apparatus, denying the request to execute the printer language command.

9. An image forming apparatus, the image forming apparatus comprising:
a memory unit, the memory unit having a firmware application which applies a policy to one or more page description languages or page description language transfer protocols, the process comprising:
creating command groups of printer language commands, each of the command groups comprises two or more printer language commands selected from one or more page description languages or page description language transfer protocols;
storing at least two printer language policies for each of the command groups in an image forming apparatus, each of the at least two printer language policies configured to concurrently control access to the two or more printer language commands of a command group for one or more users during an execution of a job, and wherein each of the at least two printer language policies is configured to be set independently of each other;
assigning at least one user to each of the at two printer language policies;
applying a printer language policy of the at least two printer language policies for the command group when a user requests the execution of the job with the one or more page description languages or page description language transfer protocols; and
executing the job based on the printer language policy assigned to the user, wherein the execution of the job comprises printing a print job on a sheet of print media according to the command group and/or displaying policy information on a display panel of the image forming apparatus according to the command group.

10. The image forming apparatus of claim 9, wherein the firmware is further configured to:
create the command groups based on printer language commands having a same function.

11. The image forming apparatus of claim 9, wherein the firmware is further configured to:
create the command groups based on printer-specific resources for the image forming apparatus.

12. The image forming apparatus of claim 9, wherein the firmware is further configured to:
create the command groups based on user attributions.

13. The image forming apparatus of claim 9, wherein the command groups comprise different page description languages, and wherein the different page description languages are selected from the following:
PostScript, Printer Command Language (PCL), Printer Job Language (PJL), Portable Document Format (PDF), XML Paper Specification (XPS), TWAIN, and IFAX.

14. The image forming apparatus of claim 9, wherein the firmware is further configured to:
look up a first policy applicable to a printer language command of the job,
when there is no first policy applicable to the printer language command of the job, look up a second policy applicable to the printer language command of the job.

15. A computer program product comprising a non-transitory computer usable medium having a computer readable code embodied therein for controlling an image forming apparatus, the computer readable program code configured to cause the image forming apparatus to execute a process for applying policy to one or more page description languages or page description language transfer protocols comprising:
creating command groups of printer language commands, each of the command groups comprises two or more printer language commands selected from one or more page description languages or page description language transfer protocols;
storing at least two printer language policies for each of the command groups in an image forming apparatus, each of the at least two printer language policies configured to concurrently control access to the two or more printer language commands of a command group for one or more users during an execution of a job, and wherein each of the at least two printer language policies is configured to be set independently of each other;
assigning at least one user to each of the at two printer language policies;
applying a printer language policy of the at least two printer language policies for the command group when a user requests the execution of the job with the one or more page description languages or page description language transfer protocols; and
executing the job based on the printer language policy assigned to the user, wherein the execution of the job comprises printing a print job on a sheet of print media according to the command group and/or displaying policy information on a display panel of the image forming apparatus according to the command group.

16. The computer program product of claim 15, comprising:
creating the command groups based on printer language commands having a same function.

17. The computer program product of claim 15, comprising:
creating the command groups based on printer-specific resources for the image forming apparatus.

18. The computer program product of claim 15, comprising:
creating the command groups based on user attributions.

19. The computer program product of claim 15, wherein the command groups comprise different page description languages, and wherein the different page description languages are selected from the following:
PostScript, Printer Command Language (PCL), Printer Job Language (PJL), Portable Document Format (PDF), XML Paper Specification (XPS), TWAIN, and IFAX.

20. The computer program product of claim 15,
when the user requests the job, looking up a first policy applicable to a printer language command of the job, and
when there is no first policy applicable to the printer language command of the job, looking up a second policy applicable to the printer language command of the job.
